(19) United States
(12) Patent Application Publication
(10) Pub. No.: US 2016/0010353 A1
(43) Pub. Date: Jan. 14, 2016

(54) Filter for swimming pool or spa skimmer

(71) Applicants: Noella Giroux, Laval (CA); Francois Giroux, Laval (CA)

(72) Inventors: Noella Giroux, Laval (CA); Francois Giroux, Laval (CA)

(21) Appl. No.: 14/798,714

(22) Filed: Jul. 14, 2015

(30) Foreign Application Priority Data
Jul. 14, 2014 (GB) 1412514.0

(51) Int. Cl. E04H 4/12; B01D 29/11

(52) U.S. Cl. CPC E04H 4/1272; B01D 29/11

(57) ABSTRACT

A filter for swimming pool and spa skimmer has a filtering mesh configurable so as to fit inside of a skimmer basket. Strips are disposed around the periphery of said filtering mesh so as to facilitate the adjustment of said filtering mesh so that it can be put up against the inner wall of said basket's inner wall.

### FIELD OF THE INVENTION

The present invention relates generally to to swimming pool but more particularly to a filter for swimming pool or spa skimmer.

### BACKGROUND OF THE INVENTION

Skimmers collect water from the surface of a pool and brings it to the pool's filtration system. All the fine dust on the water surface gets through the skimmer and into the filtering system. After a while, the filtering system gets dirty and needs to be back washed. This process wastes a lot of water which needs to be replaced, generally by cold water which cools down the temperature of the water in the pool. This is particularly noticeable in heated swimming pools or spas. Besides surface skimmers, in ground pools also have a bottom filter to also collect dust and debris that have sunk.

### SUMMARY OF THE INVENTION

In view of the foregoing disadvantages inherent in the known devices now present in the prior art, the present invention, which will be described subsequently in greater detail, is to provide objects and advantages which are:

To provide for a filter located inside a skimmer, or at the bottom of a pool, or in a spa, so as to eliminate the aforementioned problems.

In order to do so, the invention comprises a filtering mesh configurable so as to fit inside of a skimmer basket.

A plurality of strips are disposed around the periphery of the filtering mesh so as to facilitate the adjustment of the filtering mesh so that it can be put up against the inner wall of the basket's inner wall.

The strips are made of resiliently deformable materials chosen from the group of galvanized steel, chrome plated iron or steel, stainless steel, zinc or aluminum.

The filtering mesh is made out of nylon, and the openings are equal to or smaller than 1 mm.

The filtering mesh is used in combination with a skimmer basket in a swimming pool or in a spa.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiment of the invention.

### BRIEF DESCRIPTION OF THE DRAWINGS

FIGS. 1a-b Isometric view of a filter and isometric view of the filter installed inside a basket.

FIGS. 2a-b Isometric view of a filter of a different size wherein the strips are shaped to fit inside a curved basket and isometric view of the filter installed inside a basket.

FIGS. 3a-b Top and side view of the basket of FIG. 1.

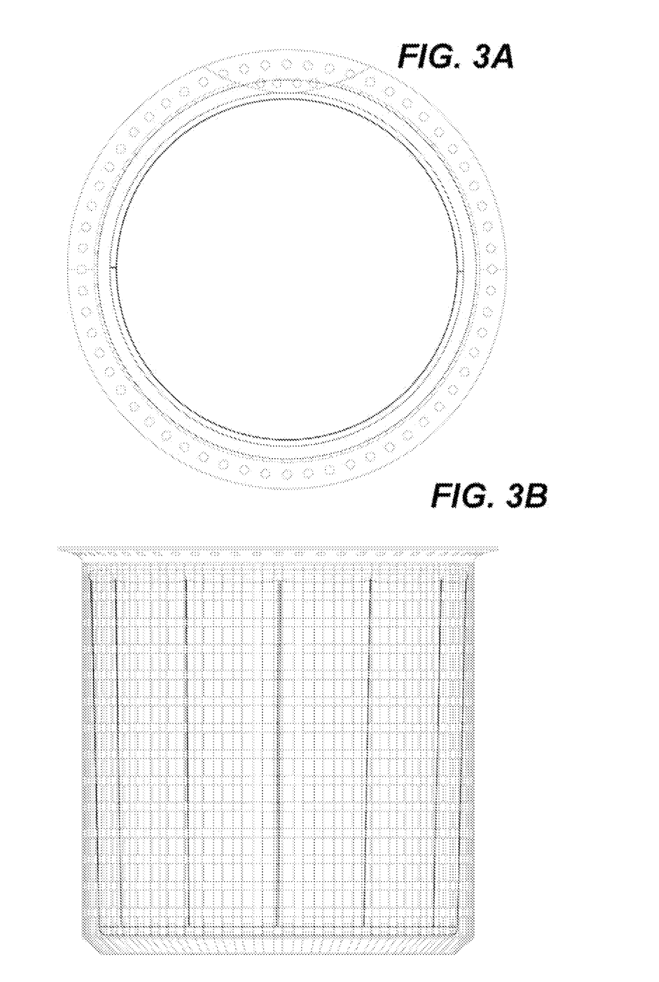

FIGS. 4a-b Top and side view of the basket of FIG. 2.

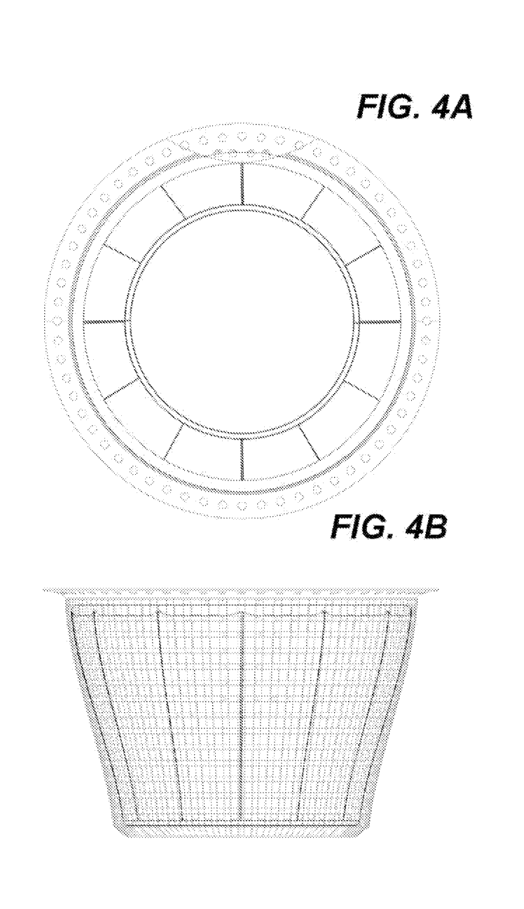

### DETAILED DESCRIPTION

A Filter for swimming pool skimmer (10) has a filtering mesh (12) configurable so as to fit inside a skimmer basket (14).

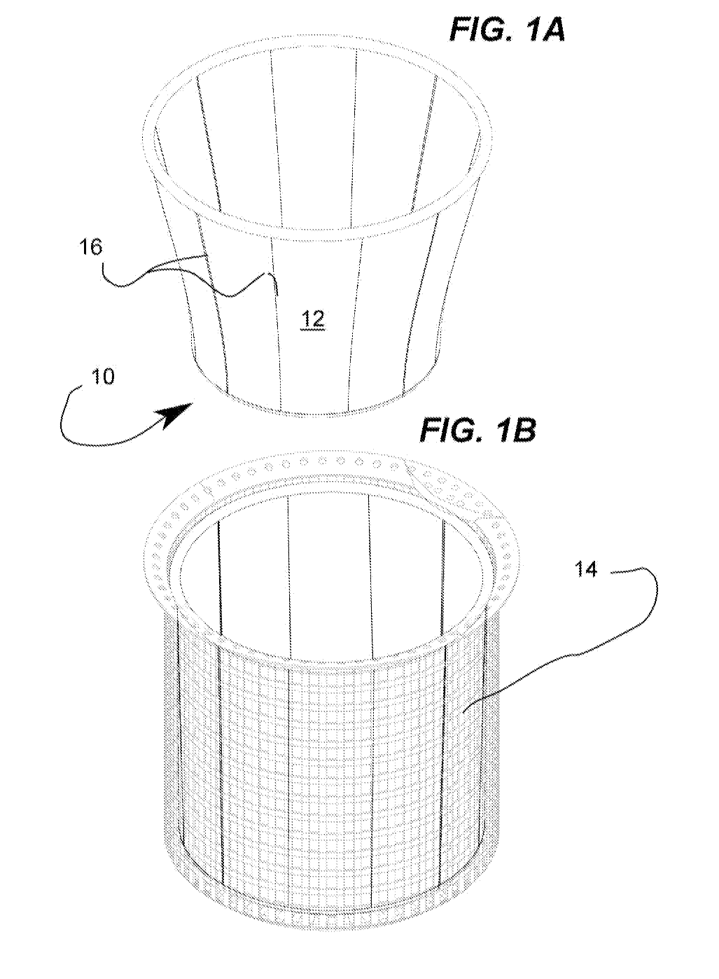

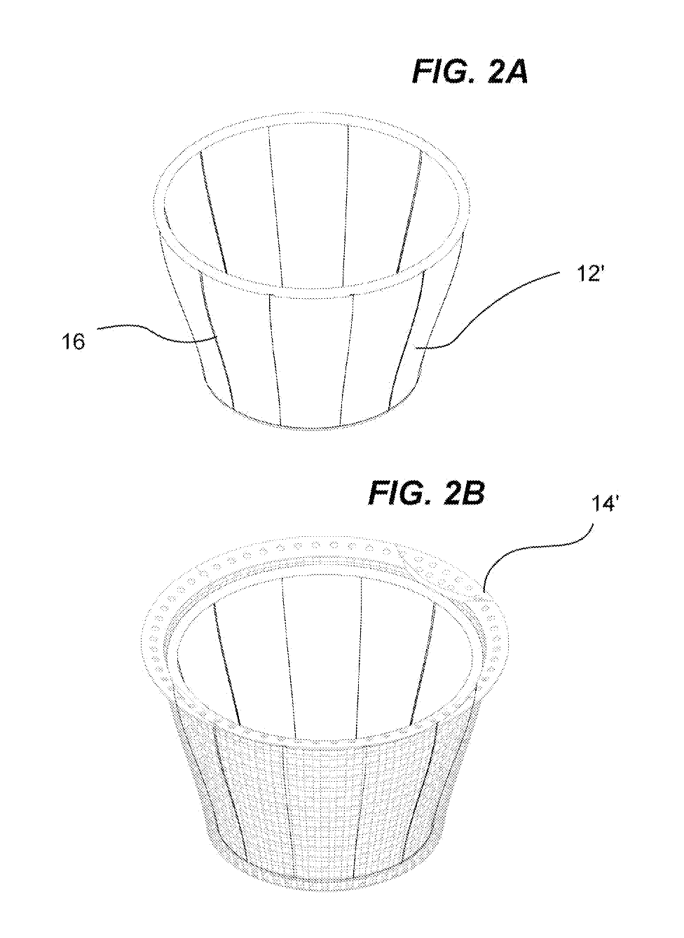

Since baskets (14) come in various shapes and sizes, a plurality of strips (16) are disposed, preferably equidistantly, around the periphery of the mesh (12) so as to easily adjust the diameter and shape of the filter so that it can be put up against the inner wall of the basket (14). For example, FIG. 2a shows a filtering mesh (12′) shaped differently than that of FIG. 1 a by way of the strips (16) so as to fit inside the basket (14′) of FIG. 2b which is shaped differently than that of FIG. 1b.

The strips (16) are made of resiliently deformable materials such as galvanized steel, chrome plated iron or steel, stainless steel, zinc or aluminum. The mesh (12) has openings of 1 mm or less.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A filter for swimming pool and spa skimmer comprising a filtering mesh configurable so as to fit inside of a skimmer basket.

2. A filter for swimming pool and spa skimmer as in claim 1 wherein strips are disposed around the periphery of said filtering mesh so as to facilitate the adjustment of said filtering mesh so that it can be put up against the inner wall of said basket's inner wall.

3. A filter for swimming pool and spa skimmer as in claim 1 wherein said strips are made of resiliently deformable materials such as galvanized steel, chrome plated iron or steel, stainless steel, zinc or aluminum

4. A filter for swimming pool and spa skimmer as in claim 1 wherein said filtering mesh is made out of nylon.

5. A filter for swimming pool and spa skimmer as in claim 1 wherein said filtering mesh has openings equal to or smaller than 1 mm.

6. A combination of a filtering mesh, a skimmer basket and a swimming pool wherein said filtering mesh is configurable so as to fit inside a skimmer basket.

7. A combination of a filtering mesh, a skimmer basket and a swimming pool as in claim 6 wherein strips are disposed around the periphery of said filtering mesh so as to facilitate the adjustment of said filtering mesh so that it can be put up against the inner wall of said basket's inner wall.

8. A combination of a filtering mesh, a skimmer basket and a swimming pool as in claim 6 wherein said strips are made of resiliently deformable materials such as galvanized steel, chrome plated iron or steel, stainless steel, zinc or aluminum

9. A combination of a filtering mesh, a skimmer basket and a swimming pool as in claim 6 wherein said filtering mesh is made out of nylon.

10. A combination of a filtering mesh, a skimmer basket and a swimming pool as in claim 6 wherein said mesh has openings equal to or smaller than 1 mm.

11. A combination of a filtering mesh, a skimmer basket and a spa wherein said filtering mesh is configurable so as to fit inside a skimmer basket.

12. A combination of a filtering mesh, a skimmer basket and a spa as in claim 11 wherein strips are disposed around the periphery of said filtering mesh so as to facilitate the adjustment of said filtering mesh so that it can be put up against the inner wall of said basket's inner wall.

13. A combination of a filtering mesh, a skimmer basket and a spa as in claim 11 wherein said strips are made of resiliently deformable materials such as galvanized steel, chrome plated iron or steel, stainless steel, zinc or aluminum

14. A combination of a filtering mesh, a skimmer basket and a spa as in claim 11 wherein said filtering mesh is made out of nylon.

15. A combination of a filtering mesh, a skimmer basket and a spa as in claim 11 wherein said mesh has openings equal to or smaller than 1 mm.
